(19) United States
(12) Patent Application Publication
(10) Pub. No.: US 2026/0030431 A1
(43) Pub. Date: Jan. 29, 2026

(54) INFORMATION PROCESSING METHOD AND INFORMATION PROCESSING APPARATUS

(71) Applicant: LegalOn Technologies, Inc., Tokyo (JP)

(72) Inventors: Manabu NAKANO, Tokyo (JP); Yuki TAKAGI, Tokyo (JP)

(21) Appl. No.: 19/346,396

(22) Filed: Sep. 30, 2025

Related U.S. Application Data
(63) Continuation of application No. PCT/JP2023/013727, filed on Mar. 31, 2023.

(51) Int. Cl. G06F 40/103; G06F 40/166

(52) U.S. Cl. CPC G06F 40/103; G06F 40/166

(57) ABSTRACT

An information processing method according to an embodiment includes acquiring first document data configured in a predetermined file format from a user terminal via a network, replacing indent information included in the first document data with new indent information according to the type of indent and the value of indent included in the indent information to generate second document data configured in the predetermined file format.

### CROSS-REFERENCE TO RELATED APPLICATIONS

This application is a U.S. national phase application filed under 35 U.S.C. § 111(a) of International Application No. PCT/JP2023/013727, filed on Mar. 31, 2023. The entire disclosure of the prior application is hereby incorporated by reference in its entirety. This application is a bypass continuation of the aforementioned international application.

### TECHNICAL FIELD

Embodiments of the present disclosure relate to an information processing method and an information processing apparatus.

### BACKGROUND

Conventionally, for the purpose of enabling setting of an appropriate indent for each layer even when a layer structure of appearance patterns of characters included in an item number is different for each document in which the item number is described, there has been proposed an information processing system including a storage in which each of appearance patterns of characters included in the item number and an appearance pattern identifier for identifying each of the appearance patterns are stored in association with each other, a conversion means that converts a character included in a head portion of a sentence in data of a document in which the item number is described into an appearance pattern identifier associated with the appearance pattern in the storage every time the character matches the character included in the appearance pattern stored in the storage, and an adjustment means that performs adjustment to indent, the same space, sentences including character strings in which converted character strings match each other (see, for example, Japanese Patent Application Laid-Open No. 2021-157590).

### SUMMARY

An information processing method according to an embodiment includes acquiring first document data configured in a predetermined file format from a user terminal via a network, replacing indent information included in the first document data with new indent information according to the type of indent and the value of indent included in the indent information to generate second document data configured in the predetermined file format.

### BRIEF DESCRIPTION OF THE DRAWINGS

FIG. 1 is a schematic diagram for describing an outline of a document creation support system according to an embodiment.

FIG. 2 is a block diagram illustrating an example of a hardware configuration of an information processing apparatus according to the embodiment.

FIG. 3 is a diagram illustrating an example of functional blocks in a processor of the information processing apparatus of the present embodiment.

FIG. 4 is a diagram illustrating an example of a replacement rule stored in a first storage unit.

FIG. 5 is a diagram illustrating an example of a left indent in XML format included in a support target document before indent replacement processing.

FIG. 6 is a diagram illustrating an example of a left indent in XML format included in a support target document after indent replacement processing.

FIG. 7 is a diagram illustrating an example of an indentation indent in XML format included in a support target document before indent replacement processing.

FIG. 8 is a diagram illustrating an example of an indentation indent in XML format included in a support target document after indent replacement processing.

FIG. 9 is a diagram illustrating an example of a left indent and a hanging indent in XML format included in a support target document before indent replacement processing.

FIG. 10 is a diagram illustrating an example of a left indent and a hanging indent in XML format included in a support target document after indent replacement processing.

FIG. 11 is a block diagram illustrating an example of a hardware configuration of a terminal apparatus according to the embodiment.

FIG. 12 is a diagram illustrating an example of functional blocks in a processor of the terminal apparatus according to the embodiment.

FIG. 13 is a flowchart illustrating a flow of editing processing including the indent replacement processing according to the present embodiment.

FIG. 14 is a flowchart illustrating an example of a flow of the indent replacement processing.

### DESCRIPTION

Hereinafter, embodiments will be described in detail with reference to the drawings. Note that, in the following description, components having substantially the same functions and configurations are denoted by the same reference numerals, and description will be made when necessary. In addition, the embodiment can be combined with other embodiments, modifications, and conventional techniques.

In conventional techniques, the adjustment of the indent may be a great burden on a user, various indent adjustment methods are demanded.

An object to be achieved by the present disclosure is to provide a technique for appropriately setting a plurality of indents included in a document in document creation support using a web browser.

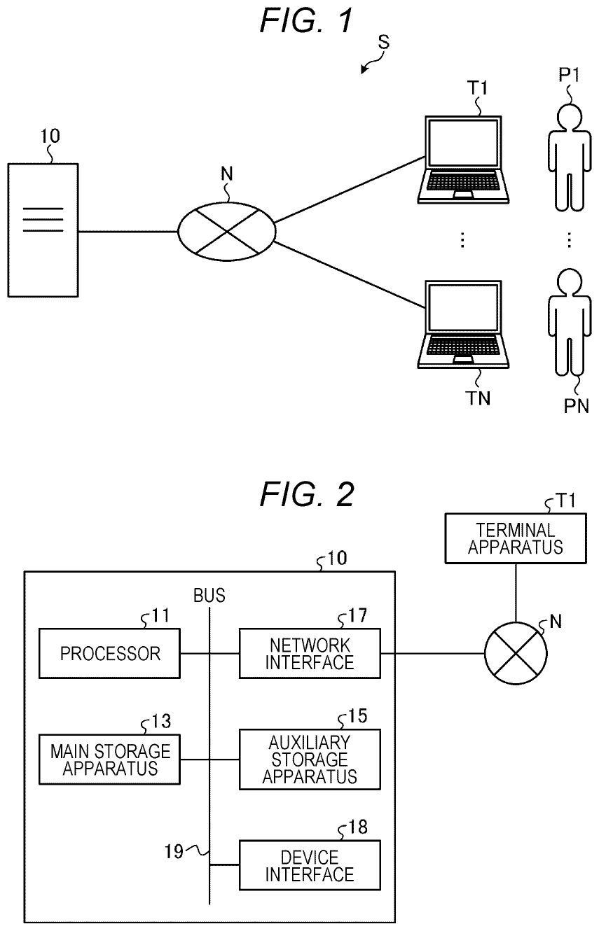

FIG. 1 is a schematic diagram for describing an outline of a document creation support system S according to the present embodiment. As illustrated in FIG. 1, the document creation support system S may function as a document creation support system, and include, for example, an information processing apparatus 10 according to the embodiment, and at least one terminal apparatus T1 to TN that can communicate with the information processing apparatus 10 via a network N. The terminal apparatuses T1 to TN may be operated by users P1 to PN, respectively. Note that the terminal apparatuses T1 to TN will be described by taking the configuration of the terminal apparatus T1 as an example.

Here, the document creation support system S may be a system that supports document creation on a browser. In the present specification, the document may mean documents in any languages created according to certain rules or standards such as certain regulations, laws, and conventions. In the present specification, document data may mean information obtained by converting a document into data in an editable manner using document creation software regardless of a data format. The document data may be typically text data, but may also include data such as image data or tabular data. In addition, the document or document data may include meta information (version, creation date, update date, creator, updater, or the like), format information (decoration such as underline and marker, font, indent, and the like), change history information, comment information, and the like created by document creation software as necessary.

Hereinafter, for the sake of specific description, a case where the document handled by the document creation support system S is a legal document (for example, an agreement) in Japanese will be described as an example. However, the document handled by the document creation support system S is not limited to agreements, and is not limited to Japanese documents. For example, it may be company regulations in English.

In the present specification, the document creation support service may be, for example, a service including at least any of executing document review processing on a support target document on a web browser and providing a result thereof to a user, executing document editing in response to an instruction from the user, saving an edited document or providing the edited document to the user, editing additional information (for example, meta information, comment information, chat information, format information, and the like) associated with the support target document, creating a new document (including a copy), comparing a plurality of documents (for example, clearly indicating difference information), and automatically proofreading the support target document.

In particular, the document creation support system S according to the present embodiment may provide a document creation support service including indent replacement processing of uniformly aligning a plurality of indents included in a document according to the type and numerical value of indent. Note that the indent replacement processing will be described below in detail.

In addition, in the present specification, the document review processing may be processing of analyzing or evaluating information included in a support target document based on certain standards and outputting a result thereof. For example, the document review processing may be processing including checking and examining whether or not information included in the support target document is appropriate based on certain standards. Specifically, for example, it may include collating wording in the document with a prepared check list, and outputting a result of the collation or an indication included in the check list. In addition, editing may mean adding, deleting, or changing information included in an editing target.

The meta information associated with the support target document may include, for example, at least one of a document ID, a type (for example, a type such as a basic transaction contract, a confidentiality contract, a service contract) of the document, a version, a creation date and time, an update date and time, and an upload date and time, a creator, an updater, a deadline, and a document ID of a related document.

The comment information associated with the support target document of the present embodiment may be, for example, additional information created by at least one user related to creation of the document, and may be associated and managed for each version of the support target document. The comment information associated with the support target document may be information different from a comment typically created by the document creation software, and may include a comment created by the document creation software as necessary.

The chat information of the present embodiment may be additional information generated by using a chat function for the support target document among a plurality of users related to creation of the support target document, and may be managed in association with, for example, a plurality of versions of the support target document. These pieces of additional information may be typically text data, but may also include other data formats such as image, voice, or the like.

The support target document of the present embodiment may be a document file uploaded from a terminal apparatus, may be a file newly created on an online editor, or may be a file already uploaded and saved or/and edited.

The terminal apparatus T1 of the present embodiment may be a client apparatus managed by the user P1 who uses the document creation support service. The terminal apparatus T1 may display a document review result and editing data on a screen of a display apparatus while associating in position the document review result and editing data with each other based on the information from the information processing apparatus 10. In the present embodiment, the user can perform operations such as indent replacement processing on the support target document, document review reference, comment input, comment reference, chat information input, chat information reference, document editing processing, and document saving by using the document review result and an editing screen displayed on the screen of the display apparatus of the terminal apparatus T1.

Next, specific configurations of the information processing apparatus 10 and the terminal apparatus T1 of the present embodiment will be described.

### (Information Processing Apparatus 10)

The information processing apparatus 10 of the present embodiment may be an apparatus that is connected to a client apparatus by communication and performs various types of processing in response to a request from the client apparatus. For example, it may be a server apparatus managed by a provider side that provides a document creation support service. The information processing apparatus 10 may provide a document creation support service to the terminal apparatus T1 in response to a document creation support request received from the terminal apparatus T1, which is a client apparatus, via the network N. Specifically, the information processing apparatus 10 of the present embodiment may execute the indent replacement processing, the document review processing, and the like of the support target document in the document creation support service. In addition, the information processing apparatus 10 may execute document editing processing in the document creation support service.

FIG. 2 is a block diagram illustrating an example of a hardware configuration of the information processing apparatus 10 according to the embodiment. As illustrated in FIG. 2, the information processing apparatus 10 may be a computer, and include, as an example, a processor 11, a main storage apparatus (memory) 13, an auxiliary storage apparatus (memory) 15, a network interface 17, a device interface 18, and a bus 19 that connects the components.

In the information processing apparatus 10 illustrated in FIG. 2, the number of each component is one, but the information processing apparatus 10 may include a plurality of the same components. In addition, although one information processing apparatus 10 is illustrated in FIG. 2, software may be installed in a plurality of computers, and each of the plurality of computers may execute the same or different partial processing of the software. In this case, there may be a form of distributed computing in which each of the computers communicates via the network interface 17 or the like to execute processing. That is, the information processing apparatus 10 of the present embodiment may be configured as a system that achieves various functions described below by one or a plurality of computers executing commands stored in one or a plurality of storage apparatuses.

Various operations of the information processing apparatus 10 may be executed in parallel processing using one or a plurality of processors or using a plurality of computers via a network. In addition, various operations may be distributed to a plurality of arithmetic cores in the processor and executed in parallel processing. In addition, some or all of the processing, means, and the like of the present disclosure may be executed by at least one of a processor and a storage apparatus provided on a cloud communicable with the information processing apparatus 10 via the network. As described above, the processing of the document creation support system S of the present embodiment may be in the form of parallel computing by one or a plurality of computers.

The processor 11 may be an electronic circuit (process circuit, processing circuit, processing circuitry, central processing unit (CPU), graphics processing unit (GPU), field programmable gate array (FPGA), application specific integrated circuit (ASIC), or the like) including a control apparatus and an arithmetic apparatus of the information processing apparatus 10. In addition, the processor 11 may be a semiconductor apparatus or the like including a dedicated processing circuit. The processor 11 is not limited to an electronic circuit using an electronic logic element, and may be achieved by an optical circuit using an optical logic element. In addition, the processor 11 may include an arithmetic function based on quantum computing.

The processor 11 can perform arithmetic processing based on data or software (program) input from each apparatus or the like of the internal configuration of the information processing apparatus 10 and output an arithmetic result or a control signal to each apparatus or the like. The processor 11 may control each component constituting the information processing apparatus 10 by executing an operating system (OS), an application, or the like of the information processing apparatus 10.

The information processing apparatus 10 of the present embodiment may be achieved by one or a plurality of processors 11. Here, the processor 11 may refer to one or a plurality of electronic circuits disposed on one chip, or may refer to one or a plurality electronic circuits disposed on two or more chips or two or more devices. When a plurality of electronic circuits is used, the electronic circuits may communicate in a wired or wireless manner.

The main storage apparatus 13 may be a storage apparatus that stores commands executed by the processor 11, various data, and the like, and information stored in the main storage apparatus 13 may be read by the processor 11. The auxiliary storage apparatus 15 may be a storage apparatus other than the main storage apparatus 13. Note that these storage apparatuses may mean arbitrary electronic components capable of storing electronic information, and may be semiconductor memories. The semiconductor memory may be either a volatile memory or a nonvolatile memory. The storage apparatus for saving various data used in the information processing apparatus 10 according to the present embodiment may be achieved by the main storage apparatus 13 or the auxiliary storage apparatus 15, or may be achieved by a built-in memory built in the processor 11. For example, a storage unit of the present embodiment may be achieved by the main storage apparatus 13 or the auxiliary storage apparatus 15.

A plurality of processors may be connected (coupled) to one storage apparatus (memory), or a single processor 11 may be connected thereto. A plurality of storage apparatuses (memories) may be connected (coupled) to one processor. In a case where the information processing apparatus 10 of the present embodiment includes at least one storage apparatus (memory) and a plurality of processors connected (coupled) to the at least one storage apparatus (memory), at least one processor among the plurality of processors may be configured to be connected (coupled) to the at least one storage apparatus (memory). In addition, this configuration may be achieved by storage apparatuses (memories) and the processors 11 included in the plurality of computers. Further, a storage apparatus (memory) may include a configuration of being integrated with the processor 11 (for example, a cache memory including an L1 cache and an L2 cache).

The network interface 17 may be an interface for connecting to the network N wirelessly or by wire. As the network interface 17, it may be sufficient if an appropriate interface such as one conforming to an existing communication standard is used. The network interface 17 may exchange information with an external apparatus connected via the network N. Note that the network N may be any of a wide area network (WAN), a local area network (LAN), a personal area network (PAN), or the like, or may be a combination thereof, as long as information is exchanged between the information processing apparatus 10 and the external apparatus. Examples of the WAN may include the Internet, examples of the LAN include IEEE802.11 and Ethernet (registered trademark), and examples of the PAN include Bluetooth (registered trademark) and near field communication (NFC).

The device interface 18 may be an interface such as a universal serial bus (USB) directly connected to an output apparatus such as a display apparatus, an input apparatus, and an external apparatus. In addition, the external apparatus may be a storage apparatus (memory), a network storage, a storage such as an HDD, or the like. In addition, the external apparatus may be an apparatus having some functions of the components of the information processing apparatus 10 of the present embodiment. That is, the information processing apparatus 10 may transmit or receive a part or the whole of the processing result of the external apparatus.

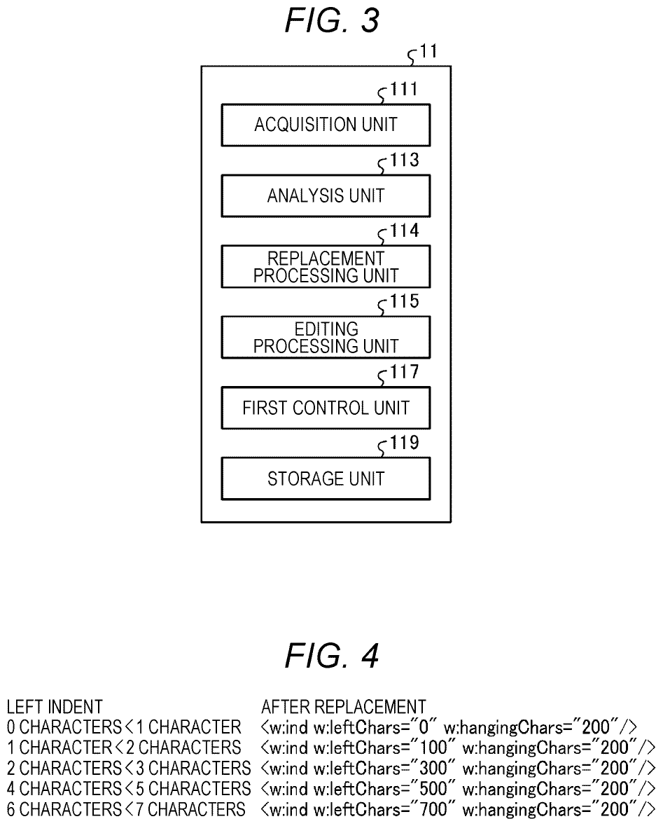

FIG. 3 is a diagram illustrating an example of functional blocks in the processor 11. The processor 11 may include, for example, an acquisition unit 111, an analysis unit 113, an editing processing unit 115, a replacement processing unit 114, a first control unit 117, and a first storage unit 119 as functions achieved by the processor 11. The functions achieved by the analysis unit 113, the editing processing unit 115, the replacement processing unit 114, the first control unit 117, and the first storage unit 119 may be stored as programs in, for example, the main storage apparatus 13 or the auxiliary storage apparatus 15. The processor 11 can achieve functions related to the analysis unit 113, the editing processing unit 115, the replacement processing unit 114, the first control unit 117, and the first storage unit 119 by reading and executing the programs stored in the main storage apparatus 13, the auxiliary storage apparatus 15, or the like.

The acquisition unit 111 of the present embodiment may acquire document data in DOCX format (an example of first document data) as a support target document via the network N. In addition, the acquisition unit 111 may acquire the document data in DOCX format stored in the first storage unit 119 as the support target document. In addition, the acquisition unit 111 may acquire the document data in DOCX format stored in the storage unit of another apparatus as the support target document via the network N.

The analysis unit 113 may execute the document review processing using, for example, the document data (an example of the first document data) of the support target document received from the acquisition unit 111. That is, the analysis unit 113 may generate document review information to be described below regarding the document data as the document review processing. Note that the document review information is an example of analysis information.

The analysis unit 113 may extract, for example, information that is included in a document (document data) and is necessary for generating review information. Various techniques can be adopted as a method for extracting the information from the document data. For example, a keyword search of the document data may be performed to extract characters, numbers, and the like included in the vicinity of the keyword. In addition, information can be extracted by morphological analysis, syntax analysis, semantic analysis, or context analysis. Further, information may also be extracted by natural language processing using machine learning. In addition, prior to these pieces of processing, information necessary for document review such as text data may be extracted from the received document data, or processing of extracting text data from image data by processing such as OCR may be performed. Note that the document review processing may be performed on the received document without extracting information necessary for generating the document review information as described above.

The analysis unit 113 may perform, for example, document review processing and generates document review information. The document review information may be based on information obtained by analyzing the document based on rules or standards applied to the document (for example, certain rules, laws, conventions). For example, the review information of the agreement as in the present embodiment can include, for example, (1) indication as to whether the clause included in the document (the agreement in the present embodiment) is advantageous or disadvantageous to the user (party), (2) advice regarding correction or deletion of the clause included in the agreement, (3) indication of missing of an item that should be normally included in the agreement and suggestion of an item to be added, and (4) information of the importance and the degree of recommendation of the item of each review result. In addition, format information such as whether the format of a sentence meets the standard, and whether a prescribed term is used may also be included.

Note that the generation of the document review information executed by the analysis unit 113 can adopt various techniques. For example, the document review information may be generated on a rule basis using the extracted information. In addition, it is also possible to use a trained model that receives the extracted information and outputs the corresponding document review information. Further, it is also possible to adopt a combination of a rule-based method and a trained model. In addition, before the generation of the document review information, the document may be divided into units of articles/sections/items and the like.

In addition, the analysis unit 113 can also generate the document review information according to the position of the user (party) by using the meta information associated with the support target document. Further, the analysis unit 113 can also generate the document review information with reference to the contents of other documents (other versions of the support target document, other agreements related to the support target document, or the like). The meta information may include those given to a document file itself such as a creator of the document and those given by a user or the like by being input separately from the file.

The editing processing unit 115 of the present embodiment may convert the data format of the support target document (document data) received via the first control unit 117 to generate editing data. For example, the editing processing unit 115 may convert the document data of a “DOCX” format file that is a support target document received via the acquisition unit 111 from XML format to “JSON” format to generate the editing data.

In addition, the editing processing unit 115 of the present embodiment may execute the editing processing on the editing data in response to an editing instruction received from the terminal apparatus T1 via the acquisition unit 111. Here, the editing processing executed by the editing processing unit 115 may include adding, deleting, and changing information included in the editing data. More specifically, addition, correction, and deletion of a word, a sentence, and a character decoration (for example, a font, a color of a character, a size of a character, a thickness of a character, an underline, a strikethrough, or the like) with respect to the editing data may be included.

In addition, the editing processing executed by the editing processing unit 115 can include format editing processing, word input assist processing, draft suggest processing, indication item extraction processing, and difference information extraction processing.

Here, the format editing processing may be, for example, processing of correcting the format of the editing data as a document. For example, indent, the line head of a bulleted list, right-alignment/left-alignment, deviation of the clause number, and the like may preferably be automatically corrected by the system by the format editing processing. The editing processing unit 115 may refer to, for example, format information of the support target document corresponding to the editing data, and execute the format editing processing on the editing data on the basis of the format information. The setting of the format as the document may preferably be saved in the information processing apparatus 10 in advance on the basis of the type of the support target document such as an agreement. For example, in the case of a legal document such as an agreement or company regulations, the clauses may be arranged in the order of articles, sections, and items in the ascending order of the clause numbers, and the indent may be set to be larger in the order of articles, sections, and items. In addition, the editing processing unit 115 may execute the format editing processing according to the type on the basis of the meta information of the support target document. Note that this format setting may be created by the user, may be provided as part of the document creation support service, or may be created by the user customizing the provided setting. In addition, the format setting of the support target document may be interpreted, and the support target document may be created based on the interpretation.

The word input assist processing of the present embodiment may be, for example, processing of assisting input by presenting a candidate word or phrase to be input next at the time of editing the document data. As a result, it is possible to support the user's input operation at the time of editing and reduce the work load. For example, words and the like that frequently appear according to the type of the support target document can be presented as input candidates. In addition, the support target document stored by the user or an organization to which the user belongs may be analyzed, and a word or the like that is often used may be presented. In addition, the user may set a word or a phrase. The editing processing unit 115 can determine an input candidate word according to the type based on the meta information of the support target document. The word and the like presented in the input assist processing may be displayed, for example, in a left window (in a document editing window) of a screen to be described below.

The draft suggest processing of the present embodiment may be processing of displaying a draft of an input candidate at the time of editing. For example, in a case where the document is an agreement, a correction sentence example based on at least a part of the correction content of the agreement may be read from a database in which a text draft sentence example is accumulated and presented as a draft candidate. As a result, it is possible to support the user's input operation at the time of editing and reduce the work load.

The editing processing unit 115 may present a predetermined draft candidate, may present a draft candidate determined by the user or the provider of the document creation support service, may present a draft candidate generated by a sentence generation service in or outside the present system using a large language model (LLM) or the like, or may present a draft candidate frequently appearing according to the type of the support target document. In addition, the support target document stored by the user or an organization to which the user belongs may be analyzed, and a draft candidate that is often used than other drafts may be presented. In a case where there is a plurality of sentence example candidates, at least one draft candidate can be selected further on the basis of an adoption frequency rate of a text in the past document creation support service (a rate at which a proposed text is selected by the user) and an adoption frequency, and a candidate with a high adoption rate can be preferentially presented to the user. Note that the draft candidate to be presented can be presented as, for example, document review information or other information.

The editing processing unit 115 can also edit the editing data in response to the editing instruction based on the presented draft candidate, for example, an instruction by a drag and drop operation. The proposed draft may be displayed in a document review area or the like to be described below by being associated with the corresponding portion of the document in position. For example, the draft candidate may be displayed close to the corresponding portion of the document. With such display, the portions corresponding to the draft candidate and the document can be compared with each other with less movement of the line of sight, and the burden on the user can be reduced.

The indication item extraction processing of the present embodiment may be to extract an indication item (for example, document review information, comment information, and chat information regarding the document data corresponding to the editing data, a correction history with respect to the editing data, a comment on the document data created by the function of the document creation software, and the like) related to at least one of the editing data and the document data corresponding to the editing data, and present the indication item to the user. The editing processing unit 115 of the present embodiment may present the extracted indication item to the user in a predetermined display form. The indication item may preferably be displayed in a list in an area not overlapping with the portion of the document indicated by the indication item, for example, the document review area displayed side by side with an editing area, or an independent (individual) window such as a pop-up window.

In addition, a combination of the indication item extraction processing and the draft suggest processing may be used to propose an indication item and a draft candidate that can resolve the indication item. At this time, it is preferable that the indication item and the draft candidate are displayed in association with the indication portion of the document in position. For example, it is preferable that the indication item and the draft candidate are displayed close to the corresponding indication item. With such display, the portions corresponding to the indication item, the draft candidate, and the document can be compared with each other with less movement of the line of sight, and the burden on the user can be reduced.

In addition, collapse display, minimization display, display size change, and the like can be executed with respect to the document review area, the pop-up window, and the like in which the indication item and the draft candidate are displayed. As a result, the user can arrange the document editing screen with a limited size such that the user can easily see the document editing screen, for example, while aligning the document editing screen with the portion of the indication in the document. In addition, on the basis of the height of the indication item or the draft candidate, each text may be displayed at a wider interval in the editing area. With such display, it is possible to more clearly and easily indicate the correspondence relationship between the indication item, the draft candidate, and the indication portion of the document.

The difference information extraction processing of the present embodiment may present difference information between the editing data before correction and the editing data after correction to the user. The editing processing unit 115 of the present embodiment may extract difference information from the editing data before correction and the editing data after correction, and present the difference information to the user in a predetermined display form, for example, by displaying the difference and the other portion (that is, the same portion) differently, for example, by emphasis display or highlighting.

The editing processing unit 115 of the present embodiment may execute various editing processing described above in response to an editing instruction received from the terminal apparatus T1. In addition, the editing processing unit 115 of the present embodiment may convert the data format of the editing data in response to the save instruction received from the terminal apparatus T1, and generate the document data to be the next version of the support target document. For example, in response to the download instruction or the save instruction received from the terminal apparatus T1, the editing processing unit 115 may generate the document data in “DOCX” format that is the next version of the support target document by using the editing data in “JSON” format. In particular, in response to the save instruction received from the terminal apparatus T1, the editing processing unit 115 of the present embodiment may generate the support target document data (an example of the second document data) in “DOCX” format on which the indent replacement processing described below is executed by using the editing data in “JSON” format.

The replacement processing unit 114 of the present embodiment may perform the indent replacement processing according to the type of indent and the numerical value of indent for a plurality of indents included in the editing data (that is, included in the support target document). More specifically, the replacement processing unit 114 may replace a plurality of indents included in the editing data with a new type of indent and a new numerical value of indent according to the type of indent and the numerical value of indent according to the replacement rule stored in the first storage unit 119.

Indent to be subjected to the indent replacement processing according to the present embodiment may be, for example, a left indent, a hanging indent, or an first line indent. That is, according to the replacement rule stored in the first storage unit 119, the replacement processing unit 114 may perform the indent replacement processing according to the type and numerical value of indent for each of the left indent, the hanging indent, and the first line indent included in the support target document.

Here, the left indent may be, for example, indentation processing of moving a paragraph of a character string from left to right as a target (unit). In a contract document, for example, it may be used with respect to a paragraph unit, a bulleted list portion, a section, and an item. The left indent may be described by an element such as “<w: left=“numerical value”>” in XML format.

In addition, the hanging indent may be, for example, indentation processing of moving the second and subsequent lines of a character string from left to right as a target (unit). In a contract document, for example, it may be used with respect to a section and an item. The hanging indent may be described by an element such as “<w: hanging=“numerical value”>” in XML format.

In addition, the first line indent may be, for example, indentation processing of moving only the first line of a character string as a target. In a contract document, for example, there is a case where it is applied to the first line of the preamble or the conclusion. The first line indent may be described by an element such as “<w: firstLine=“numerical value”>”.

Note that, in the indent processing, the left indent, the hanging indent, and the first line indent may be defined by a combination of a plurality of indents of different types or the same type, for example, the left indent and the hanging indent.

Here, a specific example of the indent replacement processing executed by the replacement processing unit 114 will be described.

FIG. 4 is a diagram illustrating an example of a replacement rule stored in the first storage unit 119. The replacement rule may define a combination of the type of indent and the value of indent before replacement, and a combination of the type of indent and the value of indent after replacement.

In FIG. 4, the column “left indent” exemplifies values (number of indentations) of the left indent visually recognized on word processing software such as Microsoft Word (registered trademark) in the terminal T1. In addition, the column “after replacement” exemplifies how to replace each value of “left indent” by the indent replacement processing in XML format. Note that numerical values such as “0” and “100” in the XML format may indicate an indent width, where 1 pt is approximately equal to 0.35 mm.

As illustrated in FIG. 4, for example, when the value of the left indent included in the support target document is “0 character-1 character” (that is, between 0 character and 1 character), the value of the left indent may be replaced with “<w:ind w:leftChars=“0” w:hangingChars=“200”/>” (that is, the indent value with respect to the entire target sentence (e.g., a paragraph) is “0”, and the indent may be replaced with a hanging indent having an indent value of “200”).

Similarly, for example, when the value of the left indent included in the support target document is “1 character-2 characters” (that is, between 1 character and 2 characters), the value of the left indent may be replaced with “<w:ind w:leftChars=“100” w:hangingChars=“200”/>” (that is, the indent value with respect to the entire target sentence (e.g., a paragraph) is “100”, and the indent may be replaced with a hanging indent having an indent value of “200”). Hereinafter, the same may apply to the case where the value of the left indent included in the support target document is “2 characters-3 characters” and the like.

Note that the replacement rule illustrated in FIG. 4 is merely an example. The replacement rule can be arbitrarily changed. For example, the user may define the desired indent replacement by changing the desired combination of the type of indent and the value of indent in the replacement rule.

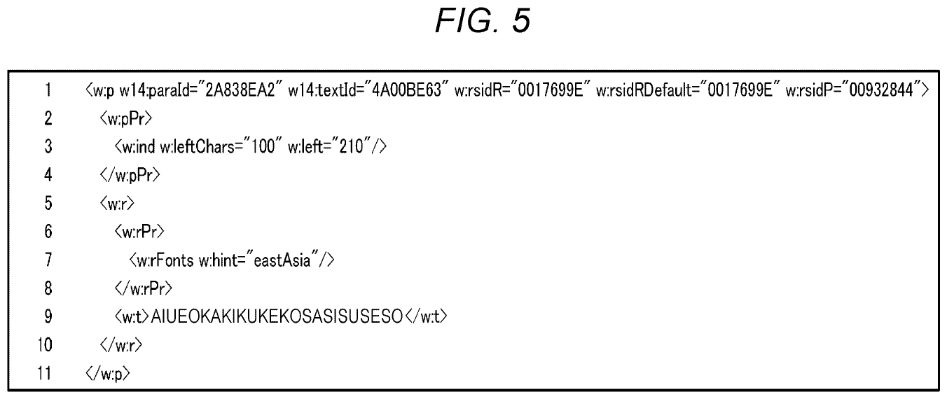

FIG. 5 is a diagram illustrating an example of a left indent in XML format included in a support target document before indent replacement processing. As illustrated in the second to fourth lines of FIG. 5, it is described as “<w:ind w:leftChars=“100” w:left=“210”/>” between elements “<w:pPr> and </w:pPr>” that designate a property for a paragraph. This may be indent processing of “when there are w:leftChars and w:left, the value of w:leftChars is prioritized, and when the defined font size is 10.5 pt from the left end of the page, the left indent of 100*10.5/100=10.5 pt is performed for the entire paragraph”.

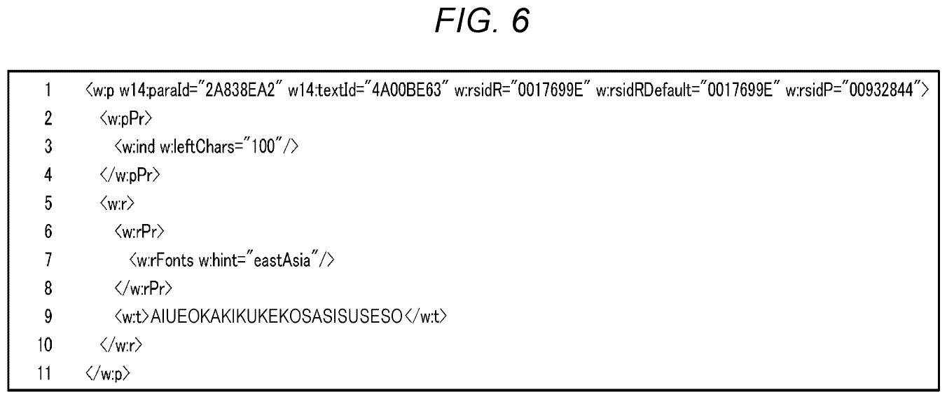

FIG. 6 is a diagram illustrating an example of a left indent in XML format included in a support target document after indent replacement processing. As illustrated in FIG. 6, in the third line, the code before replacement “<w:ind w:leftChars=“150” w:left=“315”/>” is replaced with “<w:ind w:leftChars=“100”/>” according to the replacement rule. As a result of the replacement, the indent processing before replacement illustrated in FIG. 5 may be changed to indent processing of “performing left indent for the entire paragraph based on the left indent of 100 points from the left end of the page”.

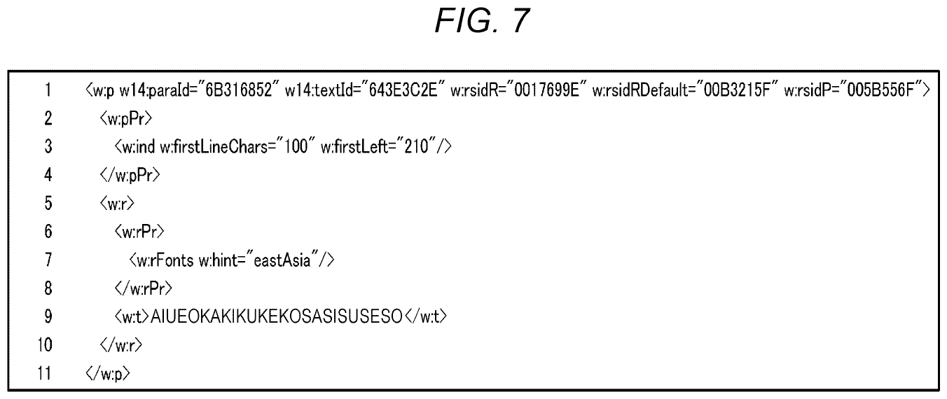

FIG. 7 is a diagram illustrating an example of an indentation indent in XML format included in a support target document before indent replacement processing. As illustrated in the second to fourth lines of FIG. 7, it is described as “<w:ind w:leftChars=“100” w:left=“210”/>” between elements “<w:pPr> and </w:pPr>” that designate a property for a paragraph. This may be indent processing of “when there are w:leftChars and w:left, the value of w:leftChars is prioritized, and when the defined font size is 10.5 pt from the left end of the page, the left indent of 100*10.5/100=10.5 pt is performed for the entire paragraph”.

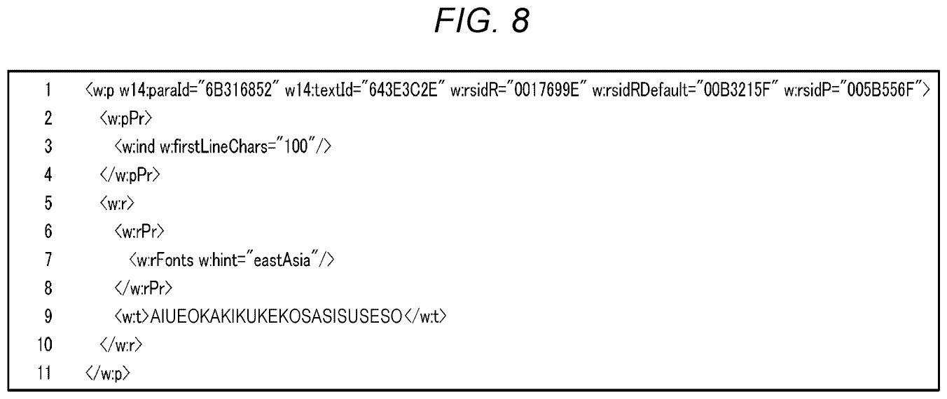

FIG. 8 is a diagram illustrating an example of an indentation indent in XML format included in a support target document after indent replacement processing. As illustrated in FIG. 8, in the third line, the code before replacement “<w:ind w:leftChars=“150” w:left=“315”/>,” which is the code before replacement illustrated in FIG. 7, is replaced with “<w:ind w:leftChars=“100”/>” according to the replacement rule. As a result of the replacement, the indent processing before replacement may be changed to indent processing of “performing first line indent of 100 points from the left end of the page for the first line of the paragraph”.

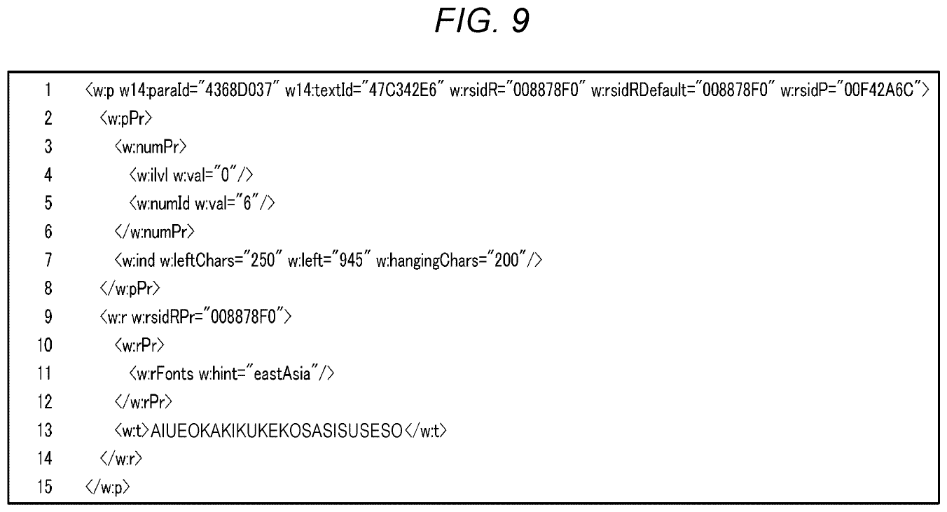

FIG. 9 is a diagram illustrating an example of a left indent and a hanging indent in XML format included in a support target document before indent replacement processing. As illustrated in the second to fourth lines of FIG. 9, the left indent is defined as an indentation of 100 points as “<w:ind w:leftChars=“250” w:left=“945” w:hangingChars=“200”/>” between elements “<w:pPr> and </w:pPr>” that designate a property for a paragraph. This may be indent processing of “performing a left indent of 945 points based on an first line indent of 250 points from the left end of the page for the entire paragraph, and performing an first line indent of 200 points based on to the left indent of 945 points for the second line of the paragraph”.

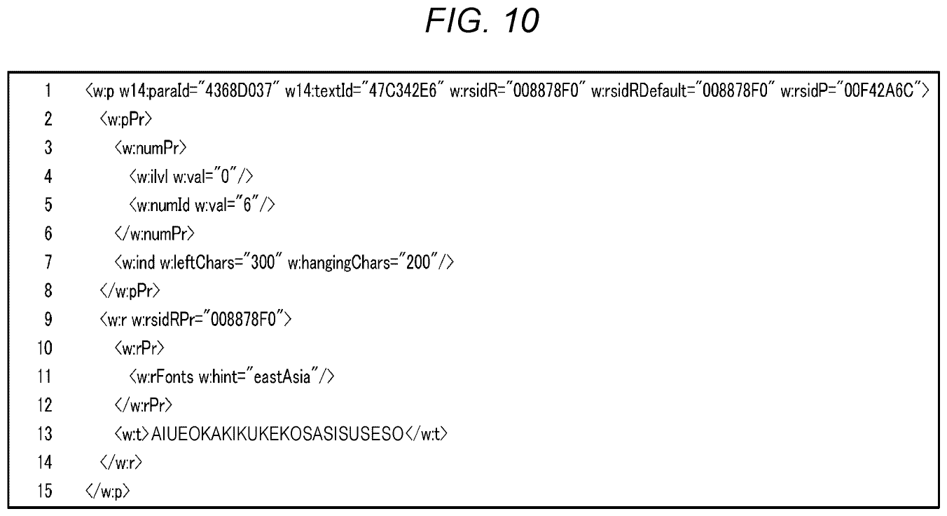

FIG. 10 is a diagram illustrating an example of a left indent and a hanging indent in XML format included in a support target document after indent replacement processing. As illustrated in FIG. 10, in the seventh line, the code before replacement “<w:ind w:leftChars=“250” w:left=“945” w:hangingChars=“200”/>” illustrated in FIG. 9 is replaced with “<w:ind w:leftChars=“300” w:hangingChars=“200”/>” according to the replacement rule. As a result of replacement, the indent processing before replacement may be changed to indent processing of “performing a left indent of 300 points from the left end of the page for the entire paragraph, and performing a hanging indent of 200 points based on the left indent of 300 points from the left end for the second line of the paragraph”.

The replacement processing unit 114 of the present embodiment may generate a support target document in DOCX format for which the indent replacement processing has been executed, from the editing data in JSON format for which the indent replacement processing has been executed. The support target document in DOCX format for which the indent replacement processing has been executed may be saved in the first storage unit 119, for example. Note that the indent replacement processing executed by the replacement processing unit 114 can also be applied to an indent of a correction sentence example presented by the draft suggest processing, and an indent prepared in advance for a correction sentence example including an article, a section, and an item. Accordingly, indent can be appropriately set in the support target document and the correction sentence example. For example, even in a case where a correction sentence example in which an indent is added to the support target document for which an indent has already been set is applied, the indent can be appropriately set.

Returning to FIG. 3, the first control unit 117 of the present embodiment may perform information communication with the terminal apparatus T1 via the network. Specifically, for example, the first control unit 117 may receive the document data, and various instructions such a document review instruction, an editing instruction, and a save instruction transmitted from the terminal apparatus T1. In addition, the first control unit 117 may transmit editing screen information (including information for executing editing processing and indent replacement processing on the terminal apparatus T1 side) to the terminal apparatus T1. The first control unit 117 may receive information including the document data after the indent replacement processing from the terminal apparatus T1.

The first control unit 117 of the present embodiment may generate layout information in the document editing processing. The layout information in the document editing processing may be, for example, information for displaying the generated editing data in a predetermined form on the browser screen of the terminal apparatus T1. Further, the first control unit 117 of the present embodiment may generate layout information in the document review processing. The layout information in the document review processing may be, for example, information for displaying the document review information generated by the document review processing and the support target document in a predetermined form on the browser screen of the terminal apparatus T1.

The layout information may associate the document review information generated by the document review processing and the support target document with each other in position. Note that the association with each other in position may refer to associating display positions so as to contribute to browsing by the user, and specifically may mean associating the positions on the screen, for example, in units of clauses, in units of paragraphs, and in units of sentences. Association in position may include, for example, displaying the corresponding portions closer to each other in the height or width direction than the other portions on the screen, and more preferably, displaying the corresponding portions side by side. In addition, in a case where the additional information is displayed together, the layout information may include information for associating the additional information, the document review information, and the editing data with each other in position.

The generation of the layout information may be performed by any method. For example, regarding a word and a phrase included in the document review information, the degree of matching may be scored for each position (for example, for each position in units of clauses or each position in units of paragraphs) in the editing data by a search function, and the layout information may be generated such that the document review information is displayed corresponding to the position of the highest score. In addition, for example, by assigning coordinates in units of clauses or in units of paragraphs of the editing data and associating the coordinates with the corresponding document review information, it is also possible to associate the display positions of the clauses and the paragraphs with the document review information.

The first control unit 117 of the present embodiment may transmit various types of information such as document review information generated by the analysis unit 113, editing data generated by the editing processing unit 115, and layout information generated by the first control unit 117 in response to a request from the terminal apparatus T1.

The first storage unit 119 may store document data uploaded from the terminal apparatus T1, document data of a new version generated from the editing data by the document editing processing, a support target document in DOCX format on which the indent replacement processing has been executed, additional information associated with each document data, and the like.

In addition, the first storage unit 119 may store a table in which the replacement rule used for the indent replacement processing is defined.

### (Terminal Apparatus T1)

The terminal apparatus T1 of the present embodiment may transmit and receive information regarding document display and document editing to and from the information processing apparatus 10 in the document creation support service.

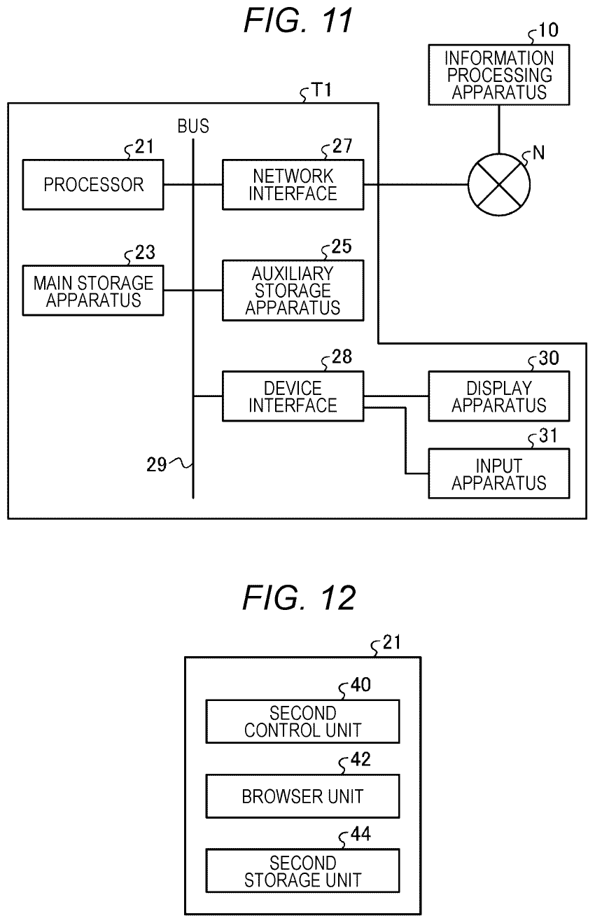

FIG. 11 is a block diagram illustrating an example of a hardware configuration of the terminal apparatus T1 according to the embodiment. As illustrated in FIG. 11, the terminal apparatus T1 may be a computer, and include, as an example, a processor 21, a main storage apparatus (memory) 23, an auxiliary storage apparatus (memory) 25, a network interface 27, a device interface 28, a bus 29 connecting the components, a display apparatus 30 connected to the device interface 28, and an input apparatus 31 connected to the device interface 28. Note that specific hardware configurations of the processor 21, the main storage apparatus 23, the auxiliary storage apparatus 25, the network interface 27, the device interface 28, and the bus 29 may be similar to those of the processor 11, the main storage apparatus 13, the auxiliary storage apparatus 15, the network interface 17, the device interface 18, and the bus 19, respectively, and thus description thereof is omitted.

The display apparatus 30 may be a display apparatus such as a liquid crystal display (LCD), a cathode ray tube (CRT), a plasma display panel (PDP), or an organic electro luminescence (EL) panel. The display apparatus 30 may display, for example, a document review screen to be described below and the document editing screen based on an instruction from the processor 21.

The input apparatus 31 may be a device such as a keyboard, a mouse, or a touch panel. The user can input various editing instructions in the document editing processing described below, for example, using the input apparatus 31. The instruction input from the input apparatus 31 may be sent to the processor 21.

Note that the terminal apparatus T1 may include another external apparatus (for example, a camera, a microphone, motion capture, various sensors, and the like) connected via the device interface 18 in order to operate and edit the document data.

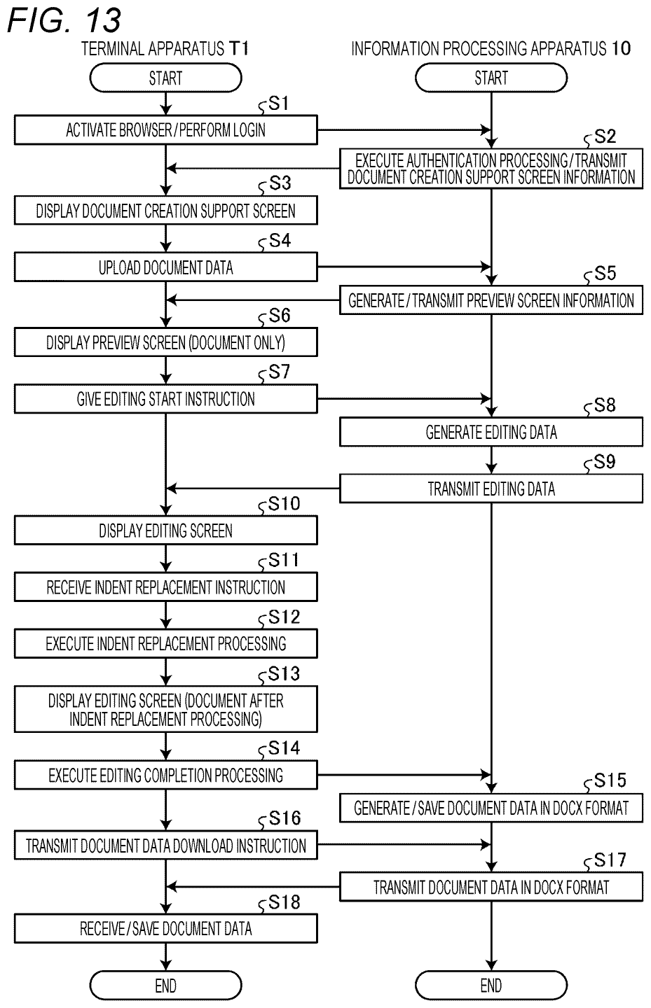

FIG. 12 is a diagram illustrating an example of functional blocks in the processor 21. The processor 21 may include, for example, a second control unit 40, a browser unit 42, and a second storage unit 44 as functions achieved by the processor 21. The functions achieved by the second control unit 40, the browser unit 42, and the second storage unit 44 may be stored as programs in, for example, the main storage apparatus 23 or the auxiliary storage apparatus 25. The processor 21 can achieve the functions related to the second control unit 40 and the browser unit 42 by reading and executing the programs stored in the main storage apparatus 23, the auxiliary storage apparatus 25, or the like.

The second control unit 40 may activate the browser unit 42 in response to an instruction from the user.

The browser unit 42 may be, for example, a general web browser, and executes processing according to hyper text markup language (HTML) data, a script (for example, JavaScript (registered trademark)), or the like. When activated, the browser unit 42 may transmit an initial access URL to the information processing apparatus 10 to access.

The browser unit 42 of the present embodiment may display, for example, data including text data and image data received from the information processing apparatus 10 on the display apparatus 30 of the terminal apparatus T1 in a predetermined form. More specifically, in the document review processing, the browser unit 42 may display the document review information, the document data, the additional information, and the like received from the information processing apparatus 10 on the display apparatus 30 of the terminal apparatus T1 in a predetermined form based on the layout information. In addition, in the document editing processing, the browser unit 42 of the present embodiment may display the document review information, the editing data, the additional information, and the like received from the information processing apparatus 10 on the display apparatus 30 of the terminal apparatus T1 in a predetermined form based on the layout information.

In addition, the browser unit 42 may transmit, for example, an indent replacement processing instruction from the user to the information processing apparatus 10. For example, the browser unit 42 may receive editing screen information (including information for executing the editing processing/the indent replacement processing) from the first control unit 117, and execute the indent replacement processing. The browser unit 42 may display the support target document on which the indent replacement processing has been executed on the display apparatus 30. The browser unit 42 may receive the support target document in DOC format on which the indent replacement processing has been executed, and store the support target document in the second storage unit 44.

The second storage unit 44 may store, for example, the support target document data before the indent replacement processing and the support target document data after the indent replacement processing in DOCX format acquired by the browser unit 42.

### (Flow of Indent Replacement Processing)

Next, an example of the editing processing including the indent replacement processing achieved by the present embodiment will be described.

FIG. 13 is a flowchart illustrating a flow of editing processing including the indent replacement processing according to the present embodiment. First, the second control unit 40 of the terminal apparatus T1 may activate the browser unit 42 in response to an instruction from the user. The browser unit 42 of the terminal apparatus T1 may transmit the initial access URL and login information such as a registration ID to the information processing apparatus 10 (step S1).

The first control unit 117 of the information processing apparatus 10 may execute authentication processing in response to the login information from the terminal apparatus T1. In addition, the first control unit 117 may transmit document creation support screen information generated by the first control unit 117 (step S2).

The browser unit 42 of the terminal apparatus T1 may display a document creation support screen on the display apparatus 30 on the basis of the document creation support screen information received from the information processing apparatus 10 (step S3).

The browser unit 42 of the terminal apparatus T1 may transmit the support target document data to the information processing apparatus 10 in response to the document upload instruction from the user (step S4). Note that this upload instruction may be performed by a user who gives a review instruction, or may be performed by a different user or/and a terminal. For example, it may be performed by a terminal of a user of another department who requests the legal department to examine the agreement.

The acquisition unit 111 of the information processing apparatus 10 may save the document data acquired (received) from the terminal apparatus T1 in the first storage unit 119. The first control unit 117 of the information processing apparatus 10 may generate document preview screen information on the basis of the document data acquired by the acquisition unit 111. The first control unit 117 of the information processing apparatus 10 may transmit the generated document preview screen information to the terminal apparatus T1 (step S5). Note that, in the present embodiment, the document preview data or the editing data to be described below may correspond to third document data.

Note that the document upload instruction and the saving of the document data in the first storage unit 119 may be performed by, for example, another user or/and another terminal of another department that requests the legal department to examine the agreement in advance of the editing processing.

The browser unit 42 of the terminal apparatus T1 may display the document preview screen on the basis of the document preview screen information received from the information processing apparatus 10 (step S6). Note that, at this stage, since it is before the document review processing, for example, only the support target document may be displayed on the document preview screen. Note that the document creation support system S of the present embodiment can be used not only for editing a document but also for browsing a document by executing step S6.

The browser unit 42 of the terminal apparatus T1 may transmit an editing start instruction input from the user to the information processing apparatus 10 (step S7).

In response to the editing start instruction from the terminal apparatus T1, the editing processing unit 115 of the information processing apparatus 10 may convert the data format of the document data into, for example, JSON format, and generate editing data (step S8).

The first control unit 117 of the information processing apparatus 10 may transmit the generated editing data and editing screen information (including information for executing editing processing/indent replacement processing on the terminal apparatus T1 side) to the terminal apparatus T1 (step S9).

The browser unit 42 of the terminal apparatus T1 may display the document editing screen on the basis of the editing data and the editing screen information received from the information processing apparatus 10 (step S10).

The browser unit 42 of the terminal apparatus T1 may receive an indent replacement instruction in response to the operation of an indent replacement button from the user (step S11).

The browser unit 42 of the terminal apparatus T1 may execute the indent replacement processing in response to the indent replacement instruction (step S12).

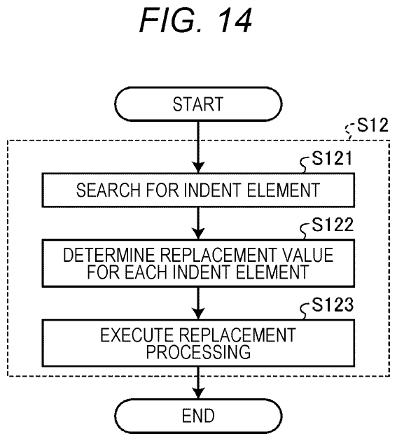

FIG. 14 is a flowchart illustrating an example of a flow of the indent replacement processing. The browser unit 42 of the terminal apparatus T1 may search for an indent element in the editing data (step S121). The browser unit 42 of the terminal apparatus T1 may determine a replacement value (that is, the new type of indent and the new value of indent after replacement) with reference to the replacement rule for each searched indent element (step S122). The browser unit 42 of the terminal apparatus T1 may execute the replacement processing according to the determination result (step S123).

Returning to FIG. 13, the browser unit 42 of the terminal apparatus T1 may display the document editing screen (document after the indent replacement processing) on the basis of the editing data after the indent replacement processing received from the information processing apparatus 10 (step S13).

In response to the operation of an editing completion button from the user, the first control unit 117 of the information processing apparatus 10 may execute editing completion processing, and transmit data reflecting the editing and an editing completion instruction to the information processing apparatus 10 (step S14).

In response to the editing completion instruction from the terminal apparatus T1, the replacement processing unit 114 of the information processing apparatus 10 may convert the data format of the editing data reflecting the edit, more specifically, after the indent replacement processing from JSON format to DOCX format, and generate the support target document data after the indent replacement processing in DOCX format. In addition, the replacement processing unit 114 of the information processing apparatus 10 may save the generated support target document data after the indent replacement processing in DOCX format in the first storage unit 119 as document data to be saved (step S15).

Note that, in step S15, the edited support target document data in DOCX format may be overwritten on the support target document data in DOCX format uploaded in step S4. In addition, the support target document data in DOCX format uploaded in step S4 and the edited support target document data in DOCX format can be saved as separate data (for example, data of a different version or a next version).

In response to the operation of the download button input from the user, the browser unit 42 of the terminal apparatus T1 may transmit an instruction to download the support target document data in DOCX format to the information processing apparatus 10 (step S16).

The first control unit 117 of the information processing apparatus 10 may transmit the edited support target document data in DOCX format to the terminal apparatus T1 (step S17).

The browser unit 42 of the terminal apparatus T1 may receive the edited support target document data in DOCX format received from the information processing apparatus 10, and save the edited support target document data in the second storage unit 44 (step S18).

Note that, in the editing processing including the indent replacement processing described above, the user can also perform the editing processing or review processing on the editing data after the indent replacement processing displayed in step S14, for example. The editing data on which the editing processing has been executed may be saved by overwriting the support target document data after the indent replacement processing generated in step S16, or may be saved as data (for example, data of a different version) different from the support target document data after the indent replacement processing generated in step S16.

Note that an URL enabling access to the edited document data may be issued without performing document data download processing. In addition, the terminal apparatus that performs download may be a terminal apparatus different from the terminal apparatus that has performed editing, and the download may be performed by a user of another department who requests the legal department to examine the agreement or the contract negotiation other party.

The information processing apparatus 10 according to the present embodiment may include the main storage apparatus 13 and the auxiliary storage apparatus 15 as at least one memory, and the processor 11 as at least one processor. The processor 11 may include the acquisition unit 111 and the replacement processing unit 114. The acquisition unit 111 may acquire the support target document data as the first document data configured in a predetermined file format (for example, the DOCX file format) from the user terminal T1 via the network N. The terminal apparatus T1 may replace the indent information included in the support target document data with new indent information according to the type of indent and the value of indent included in the indent information, and the replacement processing unit 114 may generate the support target document data in DOCX format on which the indent replacement processing has been executed.

Accordingly, for example, even in a case where a plurality of indents is included in the support target document and the format is not uniform, the plurality of indents can be quickly and easily replaced with indents of a determined pattern. For example, when a new contract document or the like is created, when copy and paste is executed from a plurality of reference documents, or when correction/additional writing, or the like is repeatedly executed by a plurality of workers, a plurality of indents that is not uniform according to a certain rule may be mixed in the support target document. With the information processing apparatus 10 according to the present embodiment, the user can quickly, simply, and accurately correct the plurality of nonuniform indents included in the support target document only by instructing the indent replacement processing on the browser screen. As a result, the work load of the user can be reduced, and the user can focus on work related to legal unique abilities.

In addition, the replacement processing unit 114 of the information processing apparatus 10 may execute the indent replacement processing according to the rule of replacing a combination of the type of indent and the value of indent with a combination of a new type of indent and a new value of indent. The type of indent may include at least one of first line indent, hanging indent, and left indent.

Accordingly, it is possible to accurately execute the indent replacement processing according to a certain rule according to the type of indent such as the first line indent, the hanging indent, and the left indent, and the value of indent. In addition, the user can adjust the indent width to a desired value by correcting the rule.

In addition, on the basis of the support target document data, the editing processing unit 115 of the information processing apparatus 10 may generate document data in JSON format, for example, as third document data for displaying the support target document data on the browser screen of the user terminal T1, and transmit the document data to the user terminal T1.

Accordingly, the user can confirm the support target document on the browser screen.

In addition, the editing processing unit 115 of the information processing apparatus 10 may edit the document data in JSON format in response to the instruction from the user terminal T1, and generate the support target document data in DOCX format on the basis of the edited document data in JSON format.

Accordingly, the user can edit the support target document after the indent replacement processing on the browser screen, and download and acquire the support target document in DOCX format after the indent replacement processing at a desired timing.

In addition, the replacement processing unit 114 of the information processing apparatus 10 may execute the indent replacement processing in response to the instruction from the user terminal T1.

Accordingly, the user can execute the indent replacement processing at a desired timing.

### First Modification

In the indent replacement processing according to the above-described embodiment, the first line indent, the hanging indent, the left indent, or a combination thereof has been described as an example. It is not limited to this example, and for example, by defining a right indent in the replacement rule, it is also possible to achieve the indent replacement processing for the right indent. The indent replacement processing including a right indent may be useful, for example, when correcting nonuniform indents in, for example, a signature field.

### Second Modification

In the indent replacement processing according to the above-described embodiment, the indent replacement processing may be executed in the user terminal T1, but may be performed in the information processing apparatus. In addition, the indent replacement processing may be performed in response to the instruction of the user, but may be automatically performed in the information processing apparatus or the user terminal T1, for example, without being based on the instruction of the user.

In addition, in response to the editing start instruction from the terminal apparatus T1, the editing processing unit 115 of the information processing apparatus 10 may convert the data format of the document data into, for example, JSON format, but it may be sufficient if this format conversion is performed at a timing when editing can be performed.

In the embodiment described above, the flow of the editing processing or the like including preview screen display of the support target document has been described as an example. However, the preview screen display of the support target document may be omitted, and the editing processing may be executed immediately after the user side receives the editing data.

### Fourth Modification

Some or all of the apparatuses in the above-described embodiments may be configured by hardware, or may be configured by information processing of software (program) executed by a CPU, a GPU, or the like. In addition, in the above embodiments, when a plurality of storage apparatuses stores data, each storage apparatus of the plurality of storage apparatuses may store only a part of the data or may store the entire data.

As described above, the information processing apparatus according to the embodiment may include at least one memory and at least one processor. The at least one processor may transmit, to the terminal apparatus, an instruction to cause the terminal apparatus to display saved first document data and review information of the first document data in association with each other in position, generate editing data based on the first document data, and edit the editing data in response to an editing instruction received from the terminal apparatus.

In addition, the information processing apparatus according to another embodiment may include at least one memory and at least one processor. The at least one processor may execute review processing on first document data to generate review information, receive an editing start instruction from the terminal apparatus that displays the first document data and the review information side by side in association with each other in position, generate editing data based on the first document data in response to the editing start instruction, edit the editing data in response to the editing instruction received by a reception unit from the terminal apparatus, and transmit the edited editing data and the review information to the terminal apparatus.

The information processing apparatus described above may generate second document data having the same data format as the first document data on the basis of the edited editing data.

In the information processing apparatus described above, display control information for displaying the editing data or the edited editing data and the review information in association with each other in position may be transmitted to the terminal apparatus.

In the information processing apparatus described above, the review information may include at least a partial correction sentence example of the first document data, and the editing may edit the editing data in response to the editing instruction based on the correction sentence example.

In the information processing apparatus described above, the first document data may be document data related to a legal document, and the review information may be obtained by reviewing the first document data on the basis of a standard of the legal document to which the first document data belongs.

In the information processing apparatus described above, the legal document may be document data related to a contract, and the at least one processor may generate the correction sentence example according to a party to the contract.

In the information processing apparatus described above, the at least one processor may transmit an instruction to cause the terminal apparatus to display the generated editing data or the edited editing data and the review information in association with each other in position in units of clauses or in units of paragraphs.

In the information processing apparatus described above, the at least one processor may execute review processing on the edited editing data to generate new review information, and transmit the generated new review information to the terminal apparatus.

In the information processing apparatus described above, the editing data may be a JSON file, and the first document data and the second document data may be DOCX files.

In the information processing apparatus described above, the editing data may include format information different from the format information of the first document data, and the second document data may include format information based on the first document data.

In the information processing apparatus described above, the at least one processor may save the second document data as a next version of the first document data.

The information processing program according to the embodiment may cause a computer to achieve a function of transmitting, to the terminal apparatus, an instruction to cause the terminal apparatus to display saved first document data and review information of the first document data in association with each other in position, a function of generating editing data based on the first document data, and a function of editing the editing data in response to an editing instruction received from the terminal apparatus.

The information processing method according to the embodiment may include transmitting, to the terminal apparatus, an instruction to cause the terminal apparatus to display saved first document data and review information of the first document data in association with each other in position, generating editing data based on the first document data, and editing the editing data in response to an editing instruction received from the terminal apparatus.

Although the embodiments of the present disclosure have been described in detail above, these embodiments have been presented as examples, and are not intended to be limited to individual embodiments. Each embodiment can be modified by various additions, changes, replacements, partial deletions, combinations, and the like without departing from the technical idea of the present invention. These embodiments and modifications thereof are included in the invention described in the claims and the equivalent scope thereof.

What is claimed is:

1. An information processing method comprising:
acquiring first document data configured in a predetermined file format from a user terminal via a network; and
replacing indent information included in the first document data with new indent information according to a type of indent and a value of indent included in the indent information to generate second document data configured in the predetermined file format.

2. The information processing method according to claim 1, wherein
the predetermined file format is a DOCX file format.

3. The information processing method according to claim 1, comprising:
executing replacement according to a rule of replacing a combination of the type of indent and the value of indent with a combination of the type of indent and a new value of indent.

4. The information processing method according to claim 1, wherein
the type of indent includes at least one of first line indent, hanging indent, left indent, and right indent.

5. The information processing method according to claim 1, further comprising:
generating third document data for displaying the first document data on a browser screen of the user terminal based on the first document data; and
transmitting the third document data to the user terminal.

6. The information processing method according to claim 5, comprising:
editing the third document data in response to an instruction from the user terminal; and
generating the second document data based on the edited third document data.

7. The information processing method according to claim 5, wherein
the third document data is configured in a JSON file format.

8. The information processing method according to claim 1, comprising:
executing replacement in response to an instruction from the user terminal.

9. The information processing method according to claim 1, wherein
the second document data is transmitted to the user terminal.

10. The information processing method according to claim 1, wherein
the second document data has a same file format as the first document data.

11. The information processing method according to claim 1, further comprising:
separately saving the first document data and the second document data.

12. The information processing method according to claim 1, further comprising:
editing the second document data in response to an instruction from the user terminal; and
generating fourth document data different from the second document data based on the edited second document data.

13. An information processing apparatus comprising:
at least one processor; and
at least one memory storing instructions that, when executed by the at least one processor, cause the information processing apparatus to:
acquire first document data configured in a predetermined file format from a user terminal via a network; and
replace indent information included in the first document data with new indent information according to a type of indent and a value of indent included in the indent information to generate second document data configured in the predetermined file format.
